(19) United States
(12) Patent Application Publication
(10) Pub. No.: US 2023/0112496 A1
(43) Pub. Date: Apr. 13, 2023

(54) Remote monitoring method, system and storage medium for sewage treatment process

(71) Applicant: Hangzhou Innovation Institute, Beihang University, Hangzhou (CN)

(72) Inventors: Chenlong Li, Hangzhou (CN); Xiaoshuang Ma, Hangzhou (CN); Feng Wang, Hangzhou (CN); Wenliang Chen, Hangzhou (CN); Changshun Yuan, Hangzhou (CN); Jun Wang, Hangzhou (CN)

(21) Appl. No.: 17/938,916

(22) Filed: Sep. 6, 2022

(30) Foreign Application Priority Data
Jul. 20, 2022 (CN) 202210857780.6

(51) Int. Cl. G05B 19/042

(52) U.S. Cl. CPC G05B 19/042; G05B 2219/2605

(57) ABSTRACT

A remote monitoring method, a system and a storage medium for a sewage treatment process are provided. The remote monitoring method for the sewage treatment process includes steps of: collecting sensor data with a sewage treatment data collection platform, wherein the sewage treatment data collection platform has at least one sensor for collecting sewage data; establishing an abnormal situation detection platform with a deep learning technology to detect an abnormal situation of the sensor data, and raising an alarm if the abnormal situation occurs; establishing an abnormal situation diagnosis platform with the deep learning technology to diagnose the detected abnormal situation, so as to determine a type of abnormal situation; and using the sensor data to optimize and control parameters of the sewage treatment process based on the deep learning technology.

### CROSS REFERENCE OF RELATED APPLICATION

The present invention claims priority under 35 U.S.C. 119(a-d) to CN 202210857780.6, filed Jul. 20, 2022.

### BACKGROUND OF THE PRESENT INVENTION

### Field of Invention

The present invention relates to network technology and security, and more particularly to a remote monitoring method, a system and a storage medium for a sewage treatment process.

### Description of Related Arts

In recent years, with the proposal of “peak carbon dioxide emissions and carbon neutrality”, Chinese economic development has changed from high energy consumption and high emission to clean and low energy consumption mode, which has brought great challenges to the ecological and environmental protection industry. As a part of the ecological and environmental protection industries, the sewage treatment process has received great attention in recent years. It is a typical complex industrial process, and its optimized operation involves multiple dynamic performance indicators. From the aspect of energy conversion, conventional sewage treatment mode essentially trades energy consumption for water quality. In order to reduce water pollution, a lot of electricity has been consumed, which indirectly generated a lot of carbon dioxide emissions, causing a negative impact on the global ecological environment. Therefore, reducing the energy and material consumption of sewage treatment is inevitable for industrial upgrading, which is closely related to the detection and diagnosis of abnormal situations as well as the multi-objective control of water quality and energy consumption in the sewage treatment process. However, the operation mechanism of the sewage treatment process is complex, which brings challenges to monitoring. In addition, conventional researches only simply detect the abnormal situations, wherein no subsequent processing strategy is involved, the detection accuracy is insufficient, and energy consumption is not comprehensively considered. In addition, it is difficult to deal with large amounts of data. Therefore, remote process monitoring of sewage treatment has become a core barrier to be broken, which has important theoretical and practical significance.

### SUMMARY OF THE PRESENT INVENTION

An object of the present invention is to provide a remote monitoring method, a system and a storage medium for a sewage treatment process, so as to solve conventional problems in such process.

Accordingly, in order to accomplish the above objects, the present invention provides a remote monitoring method for a sewage treatment process, comprising steps of:

collecting sensor data with a sewage treatment data collection platform, wherein the sewage treatment data collection platform has at least one sensor for collecting sewage data;

establishing an abnormal situation detection platform with a deep learning technology to detect an abnormal situation of the sensor data, and raising an alarm if the abnormal situation occurs;

establishing an abnormal situation diagnosis platform with the deep learning technology to diagnose the detected abnormal situation, so as to determine a type of abnormal situation; and using the sensor data to optimize and control parameters of the sewage treatment process based on the deep learning technology.

Preferably, the sensor of the sewage treatment data collection platform comprises a temperature sensor, an acidity meter, an alkalinity meter, a flow meter, a camera, and a millimeter-wave radar.

Preferably, establishing the abnormal situation detection platform with the deep learning technology to detect the abnormal situation of the sensor data comprises specific steps of:

establishing an abnormal situation detection model by adopting a Legendre deep network model; establishing a detection standard with a residual generator; and

detecting the abnormal situation in the sewage treatment process; wherein the Legendre deep network model adopts a learning algorithm for learning, and the learning algorithm is selected from a group consisting of a BP (Back Propagation) learning algorithm, an RLS (Recursive Least Square) learning algorithm, and an L-M (Levenberg-Marquardt) learning algorithm;

establishing the abnormal situation diagnosis platform with the deep learning technology to diagnose the detected abnormal situation, so as to determine a type of abnormal situation comprises specific steps of: establishing an abnormal situation diagnosis model; categorizing abnormal reasons; and diagnosing and classifying the detected abnormal situation in the sewage treatment process;

using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

Preferably, the Legendre deep network model is a 4-layer network, which is divided into an input layer, an output layer, a first intermediate layer, and a second intermediate layer; the first intermediate layer and the second intermediate layer are connected by a shared network weight, and the second intermediate layer and the output layer are fully connected;

a t-dimensional system is expressed as follows, and an expansion thereof is in a Legendre polynomial form:

$${x}_{j} ( k + 1 ) = {\sum }_{p = 1}^{N ( t , m )} {w}_{p} ( k ) {\prod }_{q = 1}^{t} {z}_{q}^{λ ( p , q )} ( k ) , j = 1 , 2 , … , t$$

wherein N(t,m) represents a total number of product terms of a t-variable function g after expanded into an m-power (m=2n, n=0,1, . . . ) approximation polynomial, wₚ(k) represents a weight coefficient of a p-th product term in the above formula, and λ(p,q) represents a power of a variable z_{q}(k) in a q-th product term, and

$${\sum }_{q = 1}^{t} λ ( p , q ) \leq m ;$$

the second intermediate layer and the output layer are fully connected:

$$\hat{y} ( k + 1 ) = {\sum }_{p = 1}^{t} {\hat{w}}_{p} ( k ) {x}_{p} ( k + 1 )$$

wherein ŷ(k+1) is an output of the Legendre deep network model, and ŵₚ(k) represents a weight coefficient of the p-th product term.

Preferably, the remote monitoring method further comprises a step of: pre-processing the sensor data to remove noise after collecting the sensor data by the sewage treatment data collection platform and before establishing the abnormal situation detection platform with the deep learning technology to detect the abnormal situation of the sensor data.

Preferably, pre-processing the sensor data to remove the noise comprises specific steps of: performing data storage and data pre-processing through a cloud server, wherein the data pre-processing comprises:

decomposing the sensor data, removing a part of high-frequency components, and reorganizing the sensor data for de-noising.

The present invention also provides a remote monitoring system for a sewage treatment process, comprises:

a sewage treatment data collection module for collecting sensor data with a sewage treatment data collection platform, wherein the sewage treatment data collection platform has at least one sensor for collecting sewage data;

an abnormality detection module for establishing an abnormal situation detection platform with a deep learning technology to detect an abnormal situation of the sensor data, which raises an alarm if the abnormal situation occurs;

an abnormality diagnosis module for establishing an abnormal situation diagnosis platform with the deep learning technology to diagnose the detected abnormal situation, so as to determine a type of abnormal situation; and

an optimal control module for using the sensor data to optimize and control parameters of the sewage treatment process based on the deep learning technology.

Preferably, the sensor of the sewage treatment data collection platform comprises a temperature sensor, an acidity meter, an alkalinity meter, a flow meter, a camera, and a millimeter-wave radar.

Preferably, establishing the abnormal situation detection platform with the deep learning technology to detect the abnormal situation of the sensor data comprises specific steps of:

establishing an abnormal situation detection model by adopting a Legendre deep network model; establishing a detection standard with a residual generator; and

detecting the abnormal situation in the sewage treatment process; wherein the Legendre deep network model adopts a learning algorithm for learning, and the learning algorithm is selected from a group consisting of a BP (Back Propagation) learning algorithm, an RLS (Recursive Least Square) learning algorithm, and an L-M (Levenberg-Marquardt) learning algorithm;

establishing the abnormal situation diagnosis platform with the deep learning technology to diagnose the detected abnormal situation, so as to determine a type of abnormal situation comprises specific steps of: establishing an abnormal situation diagnosis model; categorizing abnormal reasons; and diagnosing and classifying the detected abnormal situation in the sewage treatment process;

using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

The present invention further provides a computer storage medium storing instructions for executing the above remote monitoring method for the sewage treatment process.

Based on the remote monitoring method, system and storage medium for the sewage treatment process, the present invention comprehensively utilizes multi-sensor information fusion strategy, deep learning technology and optimal control technology to establish a control platform, which performs multi-objective control on abnormal water quality and energy consumption of the sewage treatment process to save energy and reduce emission, thereby contributing to “peak carbon dioxide emissions and carbon neutrality”. The above results can be displayed on a display platform, supporting local and remote viewing of the monitoring results. The remote monitoring system and method for the sewage treatment process of the present invention solves the problems of monitoring accuracy and energy waste in the conventional sewage treatment processes. With information fusion technology, data processing technology, deep learning technology, fault detection and diagnosis technology, optimal control technology and other technologies, a novel design and implementation scheme of a remote monitoring system for the sewage treatment process is provided, which has the beneficial effects such as wide monitoring range, comprehensive monitoring indicators, high intelligence and low energy consumption.

### BRIEF DESCRIPTION OF THE DRAWINGS

FIG. 1 is a flowchart of a remote monitoring method for a sewage treatment process according to an embodiment 1 of the present invention;

FIG. 2 is a structural view of a residual generator of an abnormal situation detection model in the sewage treatment process according to the embodiment 1 of the present invention;

FIG. 3 is an overall modeling process of a learning algorithm according to the embodiment 1 of the present invention;

FIG. 4 is an overall optimal control scheme of the sewage treatment process according to the embodiment 1 of the present invention;

FIG. 5 is a structural view of a Legendre deep network model according to the embodiment 1 of the present invention;

FIG. 6 is a block diagram of a remote monitoring platform for the sewage treatment process according to the embodiment 1 of the present invention; and

FIG. 7 illustrates a remote monitoring system for the sewage treatment process according to and embodiment 2 of the present invention.

### DETAILED DESCRIPTION OF THE PREFERRED EMBODIMENT

The present invention will be further described below in conjunction with the accompanying drawings and embodiments. It should be understood that the embodiments described are exemplary only and not intended to be limiting. In addition, for the convenience of description, related parts rather than overall structures are shown in the drawings.

### Embodiment 1

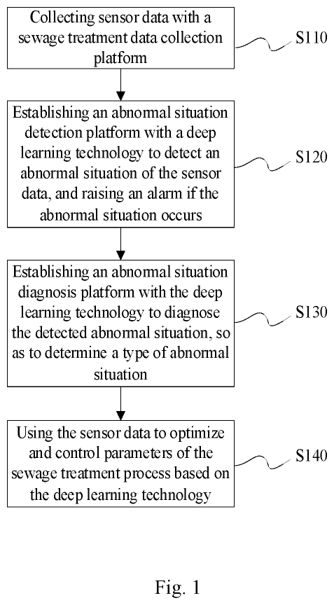

FIG. 1 is a flowchart of a remote monitoring method for a sewage treatment process according to the embodiment 1 of the present invention, comprising steps of:

S110: collecting sensor data with a sewage treatment data collection platform, wherein the sewage treatment data collection platform has at least one sensor for collecting sewage data; the sensor of the sewage treatment data collection platform comprises a temperature sensor, an acidity meter, an alkalinity meter, a flow meter, a camera, and a millimeter-wave radar;

S120: establishing an abnormal situation detection platform with a deep learning technology to detect an abnormal situation of the sensor data, and raising an alarm if the abnormal situation occurs;

S130: establishing an abnormal situation diagnosis platform with the deep learning technology to diagnose the detected abnormal situation, so as to determine a type of abnormal situation; and

S140: using the sensor data to optimize and control parameters of the sewage treatment process based on the deep learning technology.

In the embodiment 1, the control platform comprises multi-objective control of abnormal water quality and energy consumption of sewage treatment, so as to achieve the purpose of energy saving and emission reduction.

In the embodiment 1, S120 comprises specific steps of:

establishing an abnormal situation detection model by adopting a Legendre deep network model; establishing a detection standard with a residual generator; and detecting the abnormal situation in the sewage treatment process; wherein the Legendre deep network model adopts a learning algorithm for learning, and the learning algorithm is selected from a group consisting of a BP learning algorithm, an RLS learning algorithm, and an L-M learning algorithm;

S130 comprises specific steps of: establishing an abnormal situation diagnosis model; categorizing abnormal reasons; and diagnosing and classifying the detected abnormal situation in the sewage treatment process;

using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

In some embodiments, the remote monitoring method further comprises a step S150 after S110 and before S120: pre-processing the sensor data to remove noise;

wherein pre-processing the sensor data to remove the noise comprises specific steps of: performing data storage and data pre-processing through a cloud server, wherein the data pre-processing comprises:

decomposing the sensor data, removing a part of high-frequency components, and reorganizing the sensor data for de-noising.

A cloud data storage and processing platform comprises a data storage module and a data pre-processing module, which can effectively store and pre-process the sensor data, thereby improving monitoring accuracy.

A data transmission platform relies on Internet transmission. The abnormal situation detection platform can detect abnormal situations in the sewage treatment process. The abnormal situation diagnosis platform can diagnose and classify the detected abnormal situation of the sewage treatment process. The control platform comprises multi-objective control of abnormal water quality and energy consumption of the sewage treatment, so as to achieve the purpose of energy saving and emission reduction.

A sewage treatment process control method of the present invention can realize the overall control of abnormality monitoring conditions and sewage treatment energy consumption, which provides a novel design and implementation scheme of the sewage treatment process control method with high control accuracy and low energy consumption. The abnormal situation detection platform is connected to alarm the abnormal situation of the sewage treatment, which comprises a terminal display module and a remote display module.

The temperature sensor can effectively collect the temperature of sewage treatment water, and the temperature directly affects the activity of microorganisms. The acidity meter and alkalinity meter can collect the pH value of sewage in the sewage treatment process. Since the pH value is the most critical indicator to control the dosage and show whether the sewage treatment meets the standard during the neutralization treatment of acid and alkali wastewater, it is particularly important to measure the PH value of sewage timely and accurately. The flow meter can collect the flow rate of sewage. The millimeter-wave radar can measure sewage level. The camera can monitor the operation, maintenance and security of the sewage process. Data storage can be performed in the cloud server, which brings convenience to remote monitoring. Data pre-processing uses data processing technology to de-noise data by decomposing, removing some high-frequency components, reorganizing and other steps, so as to pre-process and improve monitoring accuracy. Abnormal situations in the sewage treatment process comprise abnormal water pH, abnormal flow and abnormal liquid level.

The abnormal situation detection model adopts the Legendre deep network model. The abnormal situation detection standard of the sewage treatment process adopts the residual generator. The multi-objective control of abnormal water quality and energy consumption of the sewage treatment adopts neural network multi-objective optimal control scheme.

The Legendre deep network model uses appropriate learning algorithm for learning, such as BP learning algorithm, RLS learning algorithm, L-M learning algorithm, preferably L-M learning algorithm.

The neural network multi-objective optimal control scheme comprises: designing a deep neural network optimizing model to obtain the optimal set values of the control variable; designing a deep neural network model to construct the sewage treatment process, and using the appropriate learning algorithm to train the deep neural network model; designing a deep neural network optimal controller to perform multi-objective optimal control of abnormal water quality and energy consumption.

The following is a preferred embodiment to illustrate specific application of the remote monitoring method for the sewage treatment process of the present invention.

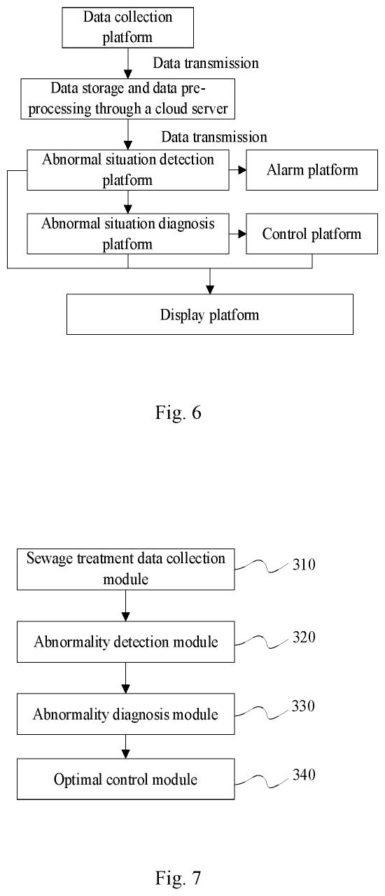

As shown in FIG. 6, the remote monitoring platform for the sewage treatment process comprises a data collection platform, a cloud data storage and processing platform, a data transmission platform, an abnormal situation detection platform, an abnormal situation diagnosis platform, a control platform, an alarm platform, and a display platform. First, the data collection platform collects the data of each sensor. Then the data are transmitted from the transmission platform to the cloud data storage and processing platform, and is pre-processed by the data processing technology to improve the monitoring accuracy. Finally, the abnormal situation detection platform, diagnosis platform and the control platform comprehensively uses multi-sensor information fusion strategy, deep learning technology, fault detection and diagnosis technology and optimal control technology to monitor the sewage treatment process while performs multi-objective control of abnormal water quality and energy consumption, so as to achieve the purpose of energy saving and emission reduction to contribute to “peak carbon dioxide emissions and carbon neutrality”. The remote monitoring system and method for the sewage treatment process of the present invention solves the problems of monitoring accuracy and energy consumption waste in the conventional sewage treatment process, and provides a novel design and implementation scheme of an intelligent sensing system for the sewage treatment process, which has the beneficial effects of wide monitoring range, comprehensive monitoring indicators, high intelligence and low energy consumption.

Implementation:

Step 1, using the data collection platform to collect sensor data.

The data collecting platform consists of temperature sensors, acidity meters, alkalinity meters, flow meters, cameras and millimeter-wave radars, which collect data from each sensor respectively.

Step 2, transmitting the sensor data to the cloud data storage and processing platform through a transmission network of the data transmission platform; and pre-processing with the data pre-processing module.

First, decomposing the original data.

Then, removing some high-frequency components from the decomposed data, and using the processed components for data denoising.

Finally, reconstructing data.

Step 3, using the abnormal situation detection platform to detect the abnormal situation of the sewage treatment process.

First, establishing the Legendre deep network model as an abnormal situation detection model.

Then, using the residual generator to construct the detection standard for sewage treatment.

Finally, detecting the abnormal situation of the sewage treatment process. If abnormality is detected, the alarm platform is connected to alarm.

Step 4, using the abnormality diagnosis platform to diagnose the abnormality of the sewage treatment process.

First, establishing the Legendre deep network model as an abnormal situation diagnosis model.

Then, according to the abnormal situation, such as water pH, flow rate and liquid level, of the sewage treatment process detected by the abnormal situation detection platform, establishing the abnormal situation classification label.

Finally, classifying with the abnormal situation diagnosis model, so as to diagnose the abnormal situation before performing follow-up processing.

Step 5: establishing a control scheme for multi-objective optimal control of abnormal water quality and energy consumption in the sewage treatment process.

First, designing the Legendre deep network optimizing model to obtain the optimal set value of the control variable.

Then, designing the Legendre deep network model to construct the sewage treatment process, and using the appropriate learning algorithm to train the deep neural network model.

Finally, designing the Legendre deep network optimal controller to perform multi-objective optimal control of abnormal water quality and energy consumption.

Step 6: checking the monitoring situation with the display module to support remote monitoring.

To sum up, the present invention combines data processing technology, data fusion technology, artificial intelligence technology and other cutting-edge sciences to provide a design scheme of a remote monitoring system for sewage treatment process. The present invention can effectively monitor and control the sewage treatment process.

The Legendre deep network model will be further described as follows.

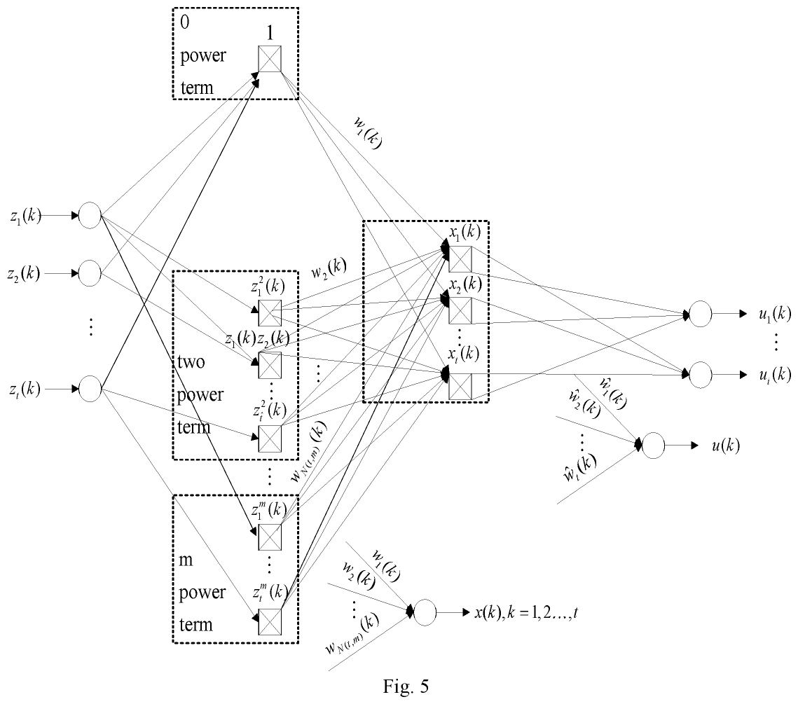

Referring to FIG. 5, the Legendre deep network model is a 4-layer network, which is divided into an input layer, an output layer, a first intermediate layer, and a second intermediate layer; the first intermediate layer and the second intermediate layer are connected by a shared network weight, and the second intermediate layer and the output layer are fully connected;

a t-dimensional system is expressed as follows, and an expansion thereof is in a Legendre polynomial form:

$${x}_{j} ( k + 1 ) = {\sum }_{p = 1}^{N ( t , m )} {w}_{p} ( k ) {\prod }_{q = 1}^{t} {z}_{q}^{λ ( p , q )} ( k ) , j = 1 , 2 , … , t$$

wherein N(t,m) represents a total number of product terms of a t-variable function g after expanded into an m-power (m=2n, n=0,1, . . . ) approximation polynomial, wₚ(k) represents a weight coefficient of a p-th product term in the above formula, and λ(p,q) represents a power of a variable z_{q}(k) in a q-th product term, and

$${\sum }_{q = 1}^{t} λ ( p , q ) \leq m ;$$

the second intermediate layer and the output layer are fully connected:

$$\hat{y} ( k + 1 ) = {\sum }_{p = 1}^{t} {\hat{w}}_{p} ( k ) {x}_{p} ( k + 1 )$$

wherein ŷ(k+1) is an output of the Legendre deep network model, and ŵₚ(k) represents a weight coefficient of the p-th product term.

The learning algorithm of the embodiment 1 will be further illustrated as follows.

The L-M (Levenberg Marquardt) algorithm is adopted, which is an improved form of the G-N(Gauss-Newton) method. The L-M algorithm has both the local feature of the Gauss-Newton method and the global feature of the gradient method.

Weight training can be achieved by the following objective function:

$$J ( k ) = \frac{1}{2} {e}^{2} ( k ) = {\frac{1}{2} [ y ( k ) - \hat{y} ( k ) ]}^{2}$$

wherein y(k) is an output of the system, ŷ(k) is an output of an MTN prediction model, and e(k)=y(k)−ŷ(k) is an error between the system output and the model output.

The L-M algorithm is derived from the Newton algorithm and the G-N algorithm. The Newton algorithm is derived from the Taylor expansion of multivariate function, and

$${- [ \frac{{\partial }^{2} J}{\partial {w}_{i}^{2}} ]}^{- 1} \frac{\partial J}{\partial {w}_{i}}$$

is a search direction. Weight update formula is as follows:

$${w}_{i + 1} = {w}_{i} - {[ \frac{{\partial }^{2} J}{\partial {w}_{i}^{2}} ]}^{- 1} \frac{\partial J}{\partial {w}_{i}}$$

wherein

$$\frac{{\partial }^{2} J}{\partial {w}_{i}^{2}} = ( \frac{\partial e}{\partial {w}_{i}} ) {( \frac{\partial e}{\partial {w}_{i}} )}^{T} + σ ( {w}_{i} )$$

is a Hessian matrix, which comprises a second-order derivative term. If the higher-order derivative term σ(wᵢ) is removed, the Newton algorithm becomes the G-N algorithm. The weight update formula is as follows:

$${w}_{i + 1} = {w}_{i} - {[ ( \frac{\partial e}{\partial {w}_{i}} ) {( \frac{\partial e}{\partial {w}_{i}} )}^{T} ]}^{- 1} \frac{\partial J}{\partial {w}_{i}}$$

When

$$( \frac{\partial e}{\partial {w}_{i}} ) {( \frac{\partial e}{\partial {w}_{i}} )}^{T}$$

is an ill-conditioned matrix, the G-N method may fall into error; especially when

$$( \frac{\partial e}{\partial {w}_{i}} ) {( \frac{\partial e}{\partial {w}_{i}} )}^{T}$$

is irreversible, the G-N algorithm is no longer applicable. In order to solve such problem, the L-M algorithm is introduced, which introduces a factor ζ on the basis of the G-N algorithm, and the weight update formula is as follows:

$${w}_{i + 1} = {w}_{i} - {[ ( \frac{\partial e}{\partial {w}_{i}} ) {( \frac{\partial e}{\partial {w}_{i}} )}^{T} + ζ I ]}^{- 1} \frac{\partial J}{\partial {w}_{i}}$$

wherein ζ is a constant and ζ≥0, which can range from 0 to a very large number. If ζ is 0, the L-M algorithm becomes the G-N algorithm. If ζ is very large, the algorithm approaches a steepest descent search, and the L-M algorithm is similar to the gradient algorithm.

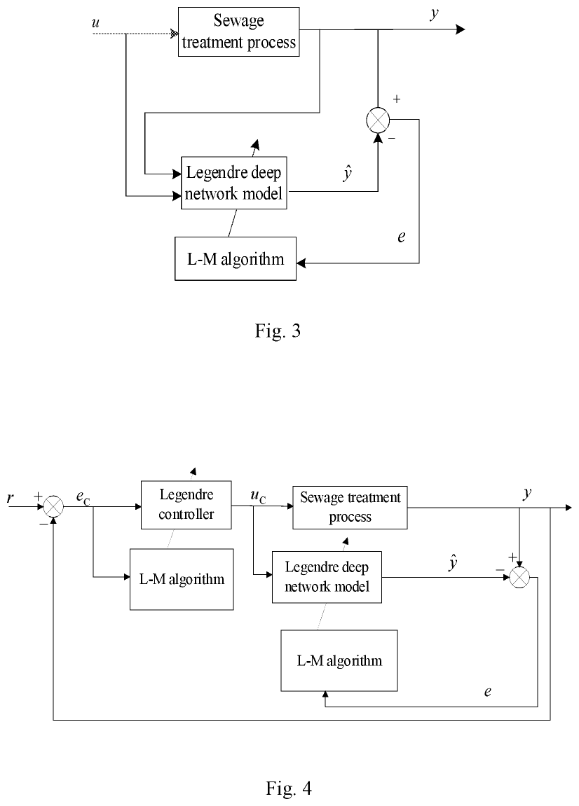

The overall modeling process is shown in FIG. 3.

According to the embodiment 1, the data pre-processing comprises steps of: Step 1, using the data collection module to collect the data of each sensor; Step 2, transmitting the sensor data to the cloud data processing module through the transmission network; and

Step 3, using the data processing module for pre-processing.

First, the original data x(t) is processed with Empirical Mode Decomposition (EMD), and a decomposition result is

$$x ( t ) = {\sum }_{i = 1}^{n} {imf}_{i} ( t ) + {r}_{n} ( t ) .$$

Each intrinsic mode function (IMF) is obtained as follows:

The maximum value envelope e₊(t) and the minimum value envelope e₋(t) are obtained by fitting all the maximum value points and minimum value points of the original data x(t) through a cubic spline function respectively. The mean of upper and lower envelopes is taken as the mean envelope m₁(t) of the original data, then:

$${m}_{1} ( t ) = \frac{{e}_{+} ( t ) + {e}_{-} ( t )}{2} .$$

The original data sequence is subtracted by m₁(t) to get a new data h₁¹ (t) whose low frequencies are removed, namely hⱼ^{j}(t)=x(t)−m₁(t).

In general, h₁¹(t) is not stationary data, and does not meet the two conditions of IMF, so the above process will be repeated. Assuming that the definition of IMF is satisfied after repeating k times, a first-order IMF component of the original data x(t) is: imfⱼ(t)=hⱼ^{j}(t);

New data r₁(t) can be obtained by subtracting the original data by imf₁(t), then: r₁(t)=x(t)−imf₁(t).

After repeating the nth-order IMF component or residual component rₙ(t) will be less than a preset value or the residual component will be a monotonic function or constant, then EMD decomposition can be stopped, and a corresponding IMF component can be obtained.

Then, the raw data is denoised. Through analysis of high-frequency IMF components, low-frequency IMF components and residual components, noise energy is mostly concentrated in high frequencies. After repeated tests and verifications, some high-frequency components can be removed from the decomposed data to obtain the processed components.

Finally, the data is reconstructed: after removing some high-frequency components, the data are reorganized, so as to obtain the EMD-processed data

$$y ( t ) = {\sum }_{i = 1}^{n} {imf}_{i}^{t} ( t ) .$$

Which high-frequency components should be removed needs to be determined by experiments.

The fault detection of the embodiment 1 will be further described below:

The abnormal situation detection platform is used to detect the abnormal situation in the sewage treatment process.

First, establishing the Legendre deep network model as the abnormal situation detection model, which has been described above; and

Then using the residual generator to construct the detection standard for sewage treatment.

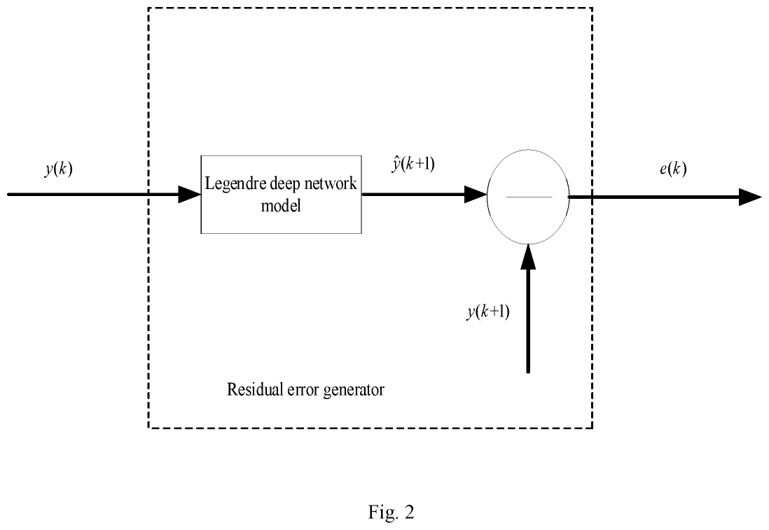

Referring to FIG. 2, the residual generator is designed based on a difference between output of the Legendre deep network model and actual output, and its idea comes from the idea of prediction process. A structure of the residual generator is shown in FIG. 2, wherein e is the output of the residual generator, ŷ(k+1) and y(+1) represent the output of the Legendre deep network model and actual output, respectively.

Threshold calculation: to achieve residual-based fault detection, a threshold selector is used for residual evaluation. The monitoring standard can be expressed as:

if r>Lₜₕ, a fault is detected; and

if r>Lₜₕ no fault;

wherein Lₜₕ is a threshold, and a variance of a residual signal can be used as a residual evaluation function:

$$Γ = \frac{1}{N - 1} {\sum }_{k = 1}^{N} {( e ( k ) - {μ}_{r} )}^{2}$$

wherein

$${μ}_{r} = \frac{1}{N} {\sum }_{k = 1}^{N} e ( k ) ,$$

N is the number of sampling points. Of course, the standard of fault detection can also be selected according to experience and experiments.

Finally, the abnormal situation of the sewage treatment process is detected. If the abnormal situation occurs, the alarm platform is connected to alarm.

The fault detection of the embodiment 1 will be further illustrated below:

First, establishing the Legendre deep network model as the abnormal situation diagnosis model;

Then, according to the abnormal situation, such as water pH, flow rate and liquid level, of the sewage treatment process detected by the abnormal situation detection platform, establishing the abnormal situation classification label;

Finally, classifying with the abnormal situation diagnosis model, wherein outputs comprise −1, 0 and 1; −1 represents abnormal water pH, 0 represents abnormal flow rate, and 1 represents abnormal liquid level. In this way, abnormal situations are diagnosed, and follow-up processing is performed according to the abnormal situations.

The specific modeling is the same as that of the above-mentioned abnormal situation detection model.

Control part of the embodiment 1 will be further described below:

1. Overall Control Scheme

First, designing the Legendre deep network optimal model to obtain the optimal set value of the control variable;

wherein model input is a water quality variable and a current energy consumption value, and a quadratic optimal form is established. The optimizing target is the water quality variable and the current energy consumption value. After optimization, the optimal set value of the control variable is obtained, which comprises the water quality variable and energy consumption value.

Then, designing the Legendre deep network model to construct the sewage treatment process, using the L-M learning algorithm to train the Legendre deep network model, and making the model converge; (see the Legendre deep network model section for details)

Finally, designing the Legendre deep network optimal controller to carry out multi-objective optimal control of the abnormal water quality and energy consumption. The Legendre deep network optimal controller means the Legendre deep network model is used as a controller.

The overall structure is shown in FIG. 4.

2. Legendre Deep Network Optimal Controller

The controller model is the Legendre deep network model, and a structure thereof is shown in FIG. 5. 4-layer network, which is divided into an input layer, an output layer, a first intermediate layer, and a second intermediate layer; the first intermediate layer and the second intermediate layer are connected by a shared network weight, and the second intermediate layer and the output layer are fully connected;

a t-dimensional system is expressed as follows, and an expansion thereof is in a Legendre polynomial form:

$${x}_{j} ( k ) = {\sum }_{p = 1}^{N ( t , m )} {w}_{p} ( k ) {\prod }_{q = 1}^{t} {z}_{q}^{λ ( p , q )} ( k ) , j = 1 , 2 , … , t$$

wherein N(t,m) represents a total number of product terms of a t-variable function g after expanded into an m-power (m=2n, n=0,1, . . . ) approximation polynomial, wₚ(k) represents a weight coefficient of a p-th product term in the above formula, and λ(p,q) represents a power of a variable z_{q}(k) in a q-th product term, and

$${\sum }_{q = 1}^{t} λ ( p , q ) \leq m , {x}_{j} ( k ) = \{ {e}_{Cj} ( k ) , {e}_{Cj} ( k - 1 ) , {e}_{Cj} ( k - 2 ) , … \} , \\ {e}_{Cj} ( k ) = {r}_{j} ( k ) - {y}_{j} ( k ) ;$$

the second intermediate layer and the output layer are fully connected:

$${u}_{Ci} ( k ) = {\sum }_{p = 1}^{t} {\hat{w}}_{p} ( k ) {x}_{p} ( k )$$

wherein u_{Cl}(k) is an output of the Legendre deep network model, and ŵₚ(k) represents a weight coefficient of the p-th product term in the formula (2).

The learning algorithm can be defined as the following objective function:

$$\begin{matrix}{J}_{C} ( k ) = \frac{1}{2} {\sum }_{j = 1}^{2} {e}_{Cj}^{2} ( k ) \\ = \frac{1}{2} {\sum }_{j = 1}^{2} {[ {r}_{j} ( k ) - {y}_{j} ( k ) ]}^{2}\end{matrix}$$

wherein rⱼ(k) is the optimal set value of the control variable, yⱼ(k) is an output. The present invention corresponds to two outputs, namely water quality variable and energy consumption value. The learning algorithm adopts the above-mentioned L-M learning algorithm.

With the foregoing features, the present invention has the following beneficial effects:

1) The present invention combines information fusion technology, data processing technology, deep learning technology, fault detection and diagnosis is technology, and optimal control technology, which designs a remote monitoring system for sewage treatment process, involving data collection platform, cloud data storage and processing platform, data transmission platform, abnormal situation detection platform, abnormal situation diagnosis platform, control platform, alarm platform and display platform. First, the data collection platform collects the data of each sensor. Then the data are transmitted from the transmission platform to the cloud data storage and processing platform to be stored, and is pre-processed by the data processing technology to provide remote viewing of monitoring conditions and improve the monitoring accuracy. Finally, the abnormal situation detection platform, diagnosis platform and the control platform are established by using the deep neural network model, which comprehensively use multi-sensor information fusion strategy, deep learning technology, fault detection and diagnosis technology and optimal control technology to detect, diagnose and control the sewage treatment process, thereby improving the monitoring accuracy and preventing energy consumption waste. The present invention achieves the purpose of energy saving and emission reduction to contribute to “peak carbon dioxide emissions and carbon neutrality”. The present invention provides a novel design and implementation scheme of an intelligent sensing system for the sewage treatment process, which has the beneficial effects of wide monitoring range, comprehensive monitoring indicators, high intelligence and low energy consumption.

2) The present invention integrates data processing technology, data fusion technology, and fault detection and diagnosis technology for an overall design of the abnormal situation detection platform in the sewage treatment process, which effectively improves the monitoring accuracy and completes the overall detection of abnormal situations in the sewage treatment process.

3) The present invention integrates data processing technology, data fusion technology, and fault detection and diagnosis technology for an overall design of the abnormal situation diagnosis platform in the sewage treatment process, which effectively improves the diagnosis accuracy and completes the classification of abnormal situations in the sewage treatment process.

4) The present invention integrates data processing technology, data fusion technology and optimal control technology to comprehensively control abnormal monitoring conditions and energy consumption problems in the sewage treatment process, which gives an overall design idea, and proposes a multi-objective optimal control scheme of the sewage treatment process based on the deep neural network. The scheme can effectively improve the control effect of abnormal situations as well as the effect of energy saving and emission reduction.

5) The present invention develops and designs a cloud data storage and processing module, which processes the collected data through data processing technology, which effectively improves the modeling accuracy. The data are stored in the cloud server, which is convenient for remote calling and control.

6) The present invention develops and designs a display platform, comprising local monitoring and remote monitoring, and supports remote monitoring and control.

According to an embodiment 2 of the present invention, a remote monitoring system for a sewage treatment process as shown in FIG. 7 is provided, which comprises:

a sewage treatment data collection module 310 for collecting sensor data with a sewage treatment data collection platform, wherein the sewage treatment data collection platform has at least one sensor for collecting sewage data;

an abnormality detection module 320 for establishing an abnormal situation detection platform with a deep learning technology to detect an abnormal situation of the sensor data, which raises an alarm if the abnormal situation occurs;

an abnormality diagnosis module 330 for establishing an abnormal situation diagnosis platform with the deep learning technology to diagnose the detected abnormal situation, so as to determine a type of abnormal situation; and an optimal control module 340 for using the sensor data to optimize and control parameters of the sewage treatment process based on the deep learning technology.

The sensor of the sewage treatment data collection platform comprises a temperature sensor, an acidity meter, an alkalinity meter, a flow meter, a camera, and a millimeter-wave radar.

Establishing the abnormal situation detection platform with the deep learning technology to detect the abnormal situation of the sensor data comprises specific steps of:

establishing an abnormal situation detection model by adopting a Legendre deep network model; establishing a detection standard with a residual generator; and detecting the abnormal situation in the sewage treatment process; wherein the Legendre deep network model adopts a learning algorithm for learning, and the learning algorithm is selected from a group consisting of a BP learning algorithm, an RLS learning algorithm, and an L-M learning algorithm;

establishing the abnormal situation diagnosis platform with the deep learning technology to diagnose the detected abnormal situation, so as to determine a type of abnormal situation comprises specific steps of: establishing an abnormal situation diagnosis model; categorizing abnormal reasons; and diagnosing and classifying the detected abnormal situation in the sewage treatment process;

using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

The system of the embodiment 2 can execute any of the remote control methods for the sewage treatment process provided in the embodiment 1, and thus can also achieve corresponding technical effects, which have been described in detail above, and will not be repeated here.

The present invention further provides a computer device, comprising a processor and a memory; the memory storing instructions for executing the remote monitoring method for the sewage treatment process as mentioned above, and thus can also achieve corresponding technical effects, which have been described in detail above, and will not be repeated here.

Accordingly, the present invention further provides a computer storage medium which stores instructions for executing the remote monitoring method for the sewage treatment process as mentioned above, and thus can also achieve corresponding technical effects, which have been described in detail above, and will not be repeated here.

It should be noted that, herein, the terms “comprise”, “comprising” or any other variation thereof are intended to encompass non-exclusive inclusion, such that a process, method, article or device comprising a series of elements without being limited thereto. It may also include other elements not expressly listed or inherent to such a process, method, article or device. Without further limitation, an element qualified by the phrase “comprising a . . . ” does not preclude the presence of additional identical elements in a process, method, article or device that includes the element.

From the description of the above embodiments, those skilled in the art can clearly understand that the methods of the above embodiments can be implemented by means of software with a necessary general hardware platform, and of course hardware can also be used. However, in many cases the former is better. Based on this, the essential technical solutions of the present invention or the parts that make contributions to the prior art can be embodied in the form of software products, and such computer software products can be stored in a storage medium (such as ROM/RAM, hard disk, CD-ROM), wherein the storage medium comprises several instructions to make a terminal device (a mobile phone, a computer, a server, an air conditioner, a network device, etc.) to execute the methods described in the above embodiments of the present invention.

The above are only preferred embodiments of the present invention, and are not intended to be limiting. Any equivalent structure or equivalent process transformation made with reference to the description and drawings of the present invention, or directly or indirectly application of the present invention in other related technical fields, are also fall into the protection scope of the present invention.

What is claimed is:

1. A remote monitoring method for a sewage treatment process, comprising steps of:
collecting sensor data with a sewage treatment data collection platform, wherein the sewage treatment data collection platform has at least one sensor for collecting sewage data;
establishing an abnormal situation detection platform with a deep learning technology to detect an abnormal situation of the sensor data, and raising an alarm if the abnormal situation occurs;
establishing an abnormal situation diagnosis platform with the deep learning technology to diagnose the detected abnormal situation, so as to determine a type of abnormal situation; and
using the sensor data to optimize and control parameters of the sewage treatment process based on the deep learning technology.

2. The remote monitoring method, as recited in claim 1, wherein the sensor of the sewage treatment data collection platform comprises a temperature sensor, an acidity meter, an alkalinity meter, a flow meter, a camera, and a millimeter-wave radar.

3. The remote monitoring method, as recited in claim 1, wherein establishing the abnormal situation detection platform with the deep learning technology to detect the abnormal situation of the sensor data comprises specific steps of:
establishing an abnormal situation detection model by adopting a Legendre deep network model; establishing a detection standard with a residual generator; and detecting the abnormal situation in the sewage treatment process; wherein the Legendre deep network model adopts a learning algorithm for learning, and the learning algorithm is selected from a group consisting of a BP learning algorithm, an RLS learning algorithm, and an L-M learning algorithm;
establishing the abnormal situation diagnosis platform with the deep learning technology to diagnose the detected abnormal situation, so as to determine a type of abnormal situation comprises specific steps of: establishing an abnormal situation diagnosis model; categorizing abnormal reasons; and diagnosing and classifying the detected abnormal situation in the sewage treatment process;
using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

4. The remote monitoring method, as recited in claim 3, wherein the Legendre deep network model is a 4-layer network, which is divided into an input layer, an output layer, a first intermediate layer, and a second intermediate layer; the first intermediate layer and the second intermediate layer are connected by a shared network weight, and the second intermediate layer and the output layer are fully connected;
a t-dimensional system is expressed as follows, and an expansion thereof is in a Legendre polynomial form:
$${x}_{j} ( k + 1 ) = {\sum }_{p = 1}^{N ( t , m )} {w}_{p} ( k ) {\prod }_{q = 1}^{t} {z}_{q}^{λ ( p , q )} ( k ) , j = 1 , 2 , … , t$$
wherein N(t,m) represents a total number of product terms of a t-variable function g after expanded into an m-power (m=2n, n=0,1, . . . ) approximation polynomial, wₚ(k) represents a weight coefficient of a p-th product term in the above formula, and λ(p,q) represents a power of a variable z_{q}(k) in a q-th product term, and
$${\sum }_{q = 1}^{t} λ ( p , q ) \leq m ;$$
the second intermediate layer and the output layer are fully connected:
$$\hat{y} ( k + 1 ) = {\sum }_{p = 1}^{t} {\hat{w}}_{p} ( k ) {x}_{p} ( k + 1 )$$
wherein ŷ(k+1) is an output of the Legendre deep network model, and ŵₚ(k) represents a weight coefficient of the p-th product term.

5. The remote monitoring method, as recited in claim 1, further comprising a step of: pre-processing the sensor data to remove noise after collecting the sensor data by the sewage treatment data collection platform and before establishing the abnormal situation detection platform with the deep learning technology to detect the abnormal situation of the sensor data.

6. The remote monitoring method, as recited in claim 5, wherein pre-processing the sensor data to remove the noise comprises specific steps of: performing data storage and data pre-processing through a cloud server, wherein the data pre-processing comprises:
decomposing the sensor data, removing a part of high-frequency components, and reorganizing the sensor data for de-noising.

7. A remote monitoring system for a sewage treatment process, comprising:
a sewage treatment data collection module for collecting sensor data with a sewage treatment data collection platform, wherein the sewage treatment data collection platform has at least one sensor for collecting sewage data;
an abnormality detection module for establishing an abnormal situation detection platform with a deep learning technology to detect an abnormal situation of the sensor data, which raises an alarm if the abnormal situation occurs;
an abnormality diagnosis module for establishing an abnormal situation diagnosis platform with the deep learning technology to diagnose the detected abnormal situation, so as to determine a type of abnormal situation; and
an optimal control module for using the sensor data to optimize and control parameters of the sewage treatment process based on the deep learning technology.

8. The remote monitoring system, as recited in claim 7, wherein the sensor of the sewage treatment data collection platform comprises a temperature sensor, an acidity meter, an alkalinity meter, a flow meter, a camera, and a millimeter-wave radar.

9. The remote monitoring system, as recited in claim 8, wherein establishing the abnormal situation detection platform with the deep learning technology to detect the abnormal situation of the sensor data comprises specific steps of:
establishing an abnormal situation detection model by adopting a Legendre deep network model; establishing a detection standard with a residual generator; and detecting the abnormal situation in the sewage treatment process; wherein the Legendre deep network model adopts a learning algorithm for learning, and the learning algorithm is selected from a group consisting of a BP learning algorithm, an RLS learning algorithm, and an L-M learning algorithm;
establishing the abnormal situation diagnosis platform with the deep learning technology to diagnose the detected abnormal situation, so as to determine a type of abnormal situation comprises specific steps of: establishing an abnormal situation diagnosis model; categorizing abnormal reasons; and diagnosing and classifying the detected abnormal situation in the sewage treatment process;
using the sensor data to optimize and control the parameters of the sewage treatment process based on the deep learning technology comprises specific steps of: establishing an operating process target model, describing dynamic features of an operating target and a system state variable, and adopting a neural network multi-objective optimal control method for multi-objective control; designing an optimizing method to obtain an optimal set value of a control variable; tracking the set value with a controller to optimize and control the sensor data in the sewage treatment process.

10. A computer storage medium storing instructions for executing the remote monitoring method for the sewage treatment process as recited in claim 1.
